(19) United States
(12) Patent Application Publication
(10) Pub. No.: US 2026/0221916 A1
(43) Pub. Date: Jul. 30, 2026

(54) METHOD FOR REDUCING AN ACOUSTIC INTERFERENCE SIGNAL OF AN ELECTRIC MACHINE AND CONTROL UNIT

(71) Applicant: Schaeffler Technologies AG & Co. KG, Herzogenaurach (DE)

(72) Inventor: Florian von Bertrab, Karlsruhe (DE)

(73) Assignee: Schaeffler Technologies AG & Co. KG, Herzogenaurach (DE)

(21) Appl. No.: 19/146,135

(22) PCT Filed: Dec. 1, 2023
(86) PCT No.: PCT/DE2023/100933

§ 371 Date: Jul. 7, 2025

(30) Foreign Application Priority Data
Jan. 10, 2023 (DE) 10 2023 100 422.0

(51) Int. Cl. H02P 23/04

(52) U.S. Cl. CPC H02P 23/04

(57) ABSTRACT

A method for reducing an acoustic interference signal of an electric machine, in which: a) a first current test signal (I) is input and the associated first acoustic system response (II) is recorded; b) a second current test signal (III), which differs from the first current test signal (I), is input and the associated second acoustic system response (IV) is recorded; c) a system function (V) is determined on the basis of the first and second acoustic system responses (VI) and the first and second current test signals (VII); and, d) current harmonics are injected into the stator windings of the electric machine using the system function (V), in order to reduce, or preferably to eliminate, the acoustic interference signal, which corresponds, in particular, to a deviation of an acoustic signal, measured during operation of the electric machine, from a target acoustic signal.

### CROSS-REFERENCE TO RELATED APPLICATIONS

This application is a U.S. national stage application under 35 U.S.C. § 371 that claims the benefit of priority under 35 U.S.C. § 365 of International Patent Application No. PCT/DE2023/100933, filed on Dec. 1, 2023, designating the United States of America, which in turn claims the benefit of priority under 35 U.S.C. §§ 119, 365 of German Patent Application No. 102023100422.0, filed on Jan. 10, 2023, the contents of which are relied upon and incorporated herein by reference in their entirety.

### FIELD OF THE DISCLOSURE

The present disclosure relates to a method for reducing an acoustic interference signal of an electric machine and to a control unit which is designed and programmed to carry out the method according to the disclosure.

### BACKGROUND OF THE DISCLOSURE

An electric machine with a high power density, such as those used in electric vehicles, for example synchronous machines or axial flux machines, can produce an acoustic interference signal, such as audible acoustic harmonics, during operation. The acoustic interference signal can also be produced by a drive train or another component of the electric vehicle, such as a vehicle body, due to a vibration caused by the electric machine. This acoustic interference signal can be a nuisance to a driver while driving an electric vehicle.

It is known that an acoustic interference signal can be reduced by injecting opposing oscillations. For this purpose, corresponding current harmonics are injected into the electric machine or into the stator windings of the electric machine. In order to accomplish this, the amplitude and phase of the current harmonics must be known in order to effectively reduce the acoustic interference signals.

### SUMMARY OF THE DISCLOSURE

It is therefore the object of the present disclosure to provide a method and a control unit which make it possible to effectively reduce an acoustic interference signal of an electric machine.

In a method according to the disclosure for reducing an acoustic interference signal of an electric machine, such as a synchronous machine or an axial flux machine, in a step a) a first current test signal is input and the associated first acoustic system response, i.e., an acoustic signal produced on the basis of the applied first current test signal, is recorded. In step b), a second current test signal, which differs from the first current test signal, is input and the associated second acoustic system response, i.e., an acoustic signal produced on the basis of the applied second current test signal, is recorded. Subsequently, in step c), a system function or a transmission function is determined on the basis of the first and second acoustic system responses and the first and second current test signals. In step d), current harmonics are injected into stator windings of the electric machine using the system function in order to reduce, and/or eliminate, the acoustic interference signal. The acoustic interference signal corresponds to a deviation of an acoustic signal, measured during operation of the electric machine, from a target acoustic signal. The system function specifies a transmission behavior from an acoustic signal or an acoustic system response to the corresponding current signal. The system function thus receives an acoustic signal and then outputs the associated current. When the deviation is input into the system function, a fault current is determined, which can then be subsequently compensated or corrected for. As a result, the current harmonics can be fed into the stator windings of the electric machine with an adapted amplitude and phase so that the acoustic interference signal can be effectively reduced and/or eliminated.

According to an aspect of the present disclosure, an operating point of the electric machine can be adjusted prior to step a) for inputting the first current test signal, and the operating point can also be adjusted during step b) for inputting the second current test signal. As a result, the same operating point of the electric machine is adjusted both when the first current test signal and the second current test signal are input so that the system function used to determine the current harmonics to be injected can be determined in a reliable and accurate manner.

According to an advantageous aspect of the present disclosure, the first current test signal or the second current test signal can be a zero signal. As a result, either the first current test signal or the second current test signal can be applied in a simple manner.

According to an aspect of the present disclosure, in step d) the deviation can be multiplied by the system function and a fault current determined thereby can be corrected for by means of a PI controller. In other words, the deviation is input into the system function in order to determine the fault current. As a result, a control signal for applying current harmonics in addition to a fundamental wave current to the stator windings of the electric machine can be determined in a simple manner so that the acoustic interference signal can be effectively reduced or eliminated.

According to a further aspect of the present disclosure, a time required to adjust the second current test signal can be recorded between steps b) and c) in order to determine or set parameters of the PI controller. As a result, the PI controller can be parameterized appropriately and the current error can be corrected for at the adjusted speed.

According to a particularly advantageous aspect of the present disclosure, step d) can be performed using the system function multiple times. As a result, it is not necessary to feed in the current test signals multiple times, i.e., each time the control signal is determined, and to determine the system function unnecessarily often. The system function can be determined, for example, when the electric machine is started, i.e., when an electric vehicle in which the electric machine is used is started, so that the current operating conditions or driving conditions are sufficiently taken into account. As a result, current harmonics can be injected quickly and acoustic interference signals can be effectively reduced.

According to a further aspect of the present disclosure, in step d) a variable of the acoustic interference signal, such as the deviation between the measured acoustic signal and the acoustic target signal, can be determined after injection of the current harmonics. As a result, it is possible to assess the effectiveness of the injection of current harmonics.

According to an aspect, a new system function can be determined by performing steps a) to c) again and then used in step d) if the variable of the acoustic interference signal (e.g., the deviation) is greater than a predetermined value. Consequently, if the injection of current harmonics does not have a sufficient effect, a new system function can be determined so that an injection of current harmonics again leads to an appropriate reduction of the acoustic interference signal.

According to an aspect of the present disclosure, different system functions can be determined and used on the basis of the operating point and/or a rotational speed of the electric machine and/or parameters of the electric machine and/or a power electronics unit for controlling the electric machine. As a result, the current harmonics can be injected in an appropriate manner for every condition so that the acoustic interference signal can be effectively reduced.

According to an aspect of the present disclosure, the acoustic signal can be measured at the electric machine and/or at a drive train and/or at a vehicle body and/or in a vehicle interior by means of an acoustic sensor, such as a structure-borne and/or an airborne sound microphone. As a result, the acoustic interference signal can be recorded in a simple manner.

According to an aspect of the present disclosure, the target acoustic signal can be determined beforehand under ideal conditions, for example on a test bench. As a result, the acoustic interference signal can be appropriately determined as the deviation of the acoustic signal measured during operation from the acoustic target signal and can therefore also be effectively reduced.

A control unit according to the disclosure is designed and programmed to carry out the method according to the previous aspects. The control unit can record measured values directly via sensors, such as acoustic sensors, for example structure-borne sound microphones or airborne sound microphones, or record the measured values indirectly via other control units. In addition, the control unit can output a control signal for controlling the electric machine in an open or closed loop to a power electronics unit, which in turn injects currents into the stator windings of the electric machine.

An embodiment of the present disclosure is described below with reference to the figures.

### BRIEF DESCRIPTION OF THE DRAWINGS

In the figures:

FIG. 1 shows a schematic view of a control system having a control unit according to the present disclosure;

FIG. 2 shows a schematic view of a filter section for determining a real part and an imaginary part of an acoustic signal;

FIG. 3 shows a schematic view of a control section for determining a control signal for a power electronics unit which controls an electric machine;

FIG. 4 shows a time diagram showing a course of a current signal in the q-direction and a course of the acoustic interference signal obtained thereby; and

FIG. 5 shows vector diagrams showing vectors of current test signals, vectors of acoustic signals obtained therefrom and a vector of a system function.

The figures are merely schematic in nature and serve solely for understanding the disclosure. Identical elements are provided with the same reference signs.

### DETAILED DESCRIPTION

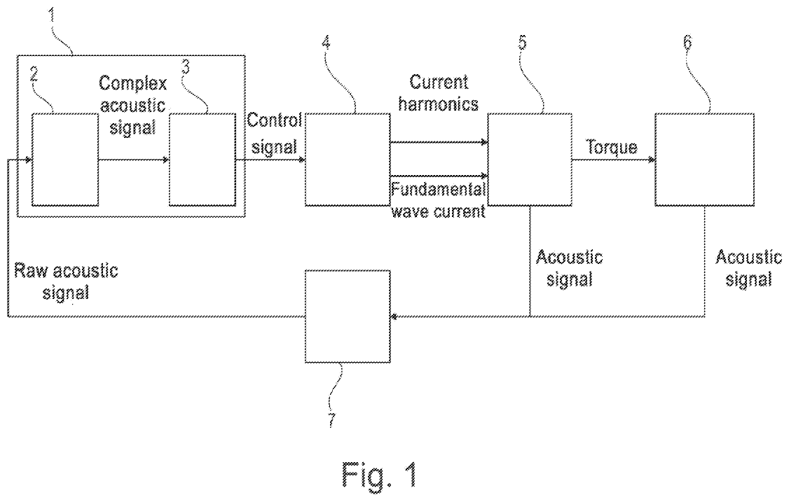

FIG. 1 shows a schematic view of a control system. The control system has a control unit 1, which in turn has a filter section 2 and a control section 3 as functional sections, a power electronics unit 4, an electric machine 5, a drive train 6 and an acoustic sensor 7. The electric machine 5 causes an acoustic interference signal during operation, which may be a nuisance to a driver while driving an electric vehicle in which the electric machine 5 is used or operated. Therefore, the acoustic interference signal must be reduced or eliminated. This is achieved by an open-loop or closed-loop control in the control unit 1, in which a control signal is determined which is output to the power electronics unit 4. The control signal causes the power electronics unit 4 to feed current harmonics into the electric machine 5 (in various implementations, into stator windings of the electric machine) in order to effectively reduce and/or eliminate the acoustic interference signal.

As mentioned above, the control unit 1 comprises functional sections for carrying out processing operations of a method according to the disclosure. The functional sections are implemented by executing software stored in the control unit 1 or by calling up data stored in the control unit 1.

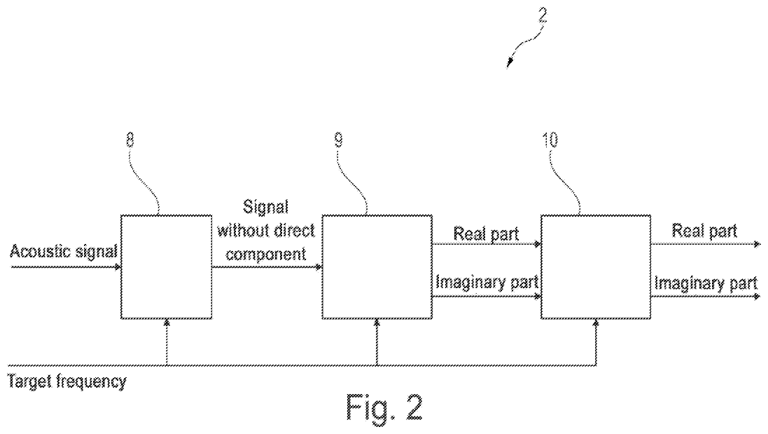

As shown in FIG. 1, the control unit 1 has a filter section 2 and a control section 3. A detailed view of the filter section 2 is shown in FIG. 2 and the filter section 2 has a high-pass filter section 8, a demodulation section 9 and a low-pass filter section 10. The filter section 2 can be used during operation in order to determine current harmonics to be fed in and during a determination of a system function described later.

As shown in FIG. 1, the acoustic sensor 7 records one or more acoustic signals at the electric machine 5 and/or at a drive train 6 of the electric vehicle. The acoustic signal can also be recorded in a vehicle interior or on a vehicle body. It is also conceivable that a plurality of acoustic sensors 7 could be used in the electric vehicle. The acoustic sensor 7 can be a structure-borne sound microphone or an airborne sound microphone. It is also conceivable that different types of acoustic sensors 7 could be combined with one another. The individual acoustic signals can be added together to form a common raw acoustic signal, which is then used as the acoustic signal.

As shown in FIG. 1, the recorded raw acoustic signal is input into the control unit 1 either in analog form or in digital form and filtered by the filter section 2. As shown in FIG. 2, the individual functional sections of the filter section 2 are adjusted to a target frequency. In this context, the target frequency passes through the integer multiples of a fundamental frequency, which is predetermined by a current to be impressed, so that the acoustic signal can be separated into the individual harmonics. It is also conceivable to adjust only predetermined harmonic frequencies. The acoustic signal is first input into the high-pass filter section 8 in order to filter out a direct component. The demodulation section 9 then converts the acoustic signal into a complex representation with real and imaginary parts at the frequency under consideration. The complex signal can then be input into the low-pass filter section 10 in order to attenuate or remove harmonics with little influence on the acoustic interference signal.

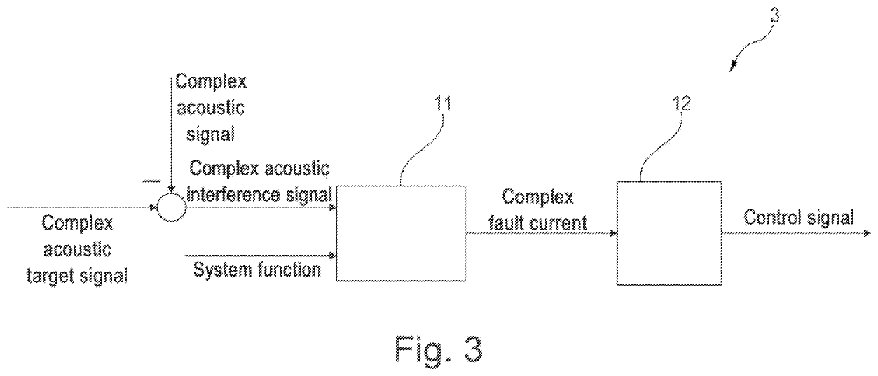

Once the complex acoustic signal consisting of the real part and imaginary part for the individual harmonic frequencies has been determined, it can be input into the control section 3, which, as shown in FIG. 3, has a section 11 for complex multiplication and a PI controller 12. In the control section 3, as shown in FIG. 3, a complex acoustic interference signal, which corresponds to a difference between a complex target acoustic signal and the complex acoustic signal, is determined first. The complex acoustic interference signal therefore corresponds to a deviation of an acoustic signal measured during operation of the electric machine from the target acoustic signal. The acoustic target signal or the complex acoustic target signal can be determined beforehand under ideal conditions, for example on a test bench. The determined complex acoustic interference signal or deviation is then input into the section 11 for complex multiplication and complex-multiplied by a system function. In other words, the complex acoustic interference signal is input into the system function.

As described above, the control unit 1 or the section 11 for complex multiplication determines the complex fault current on the basis of the system function. This determination is described below. In this regard, the complex acoustic signal for determining the system function is determined by the filter section 2 of the control unit 1. It should be noted that when determining the system function, it is assumed that the measured acoustic signal at a considered frequency, i.e., the target frequency, depends linearly on the current harmonics in a d/q coordinate system.

First, an inverse system function is determined. A relationship between the applied current signal and the acoustic system response, which corresponds to the acoustic signal with the applied current signal, can be given for a frequency under consideration by the following equation (1), which links complex variables.

$$\vec{{p}_{h}} ( \vec{{I}_{h}} ) = \vec{{p}_{h 0}} + \vec{{T}^{- 1}} \cdot \vec{{I}_{h}} \qquad Equation ( 1 )$$

Here, \vec{pₕ} is the vector of the acoustic system response at the target frequency, \vec{pₕ₀} is a constant direct component of the acoustic system response, \vec{Iₕ} is the vector of the applied current signal at the target frequency and \vec{T⁻¹} is the vector of the complex inverse system function at the target frequency. Consequently, the acoustic signal is composed of the constant direct component \vec{pₕ₀} and a component which is influenced by the current signal \vec{Iₕ}.

In order to now be able to determine the inverse system function \vec{T⁻¹} without having to consider or determine the constant direct component \vec{pₕ₀}, two predetermined current test signals can be applied and the resulting acoustic signals be recorded. The acoustic signal determined in this way can also be referred to as the acoustic system response.

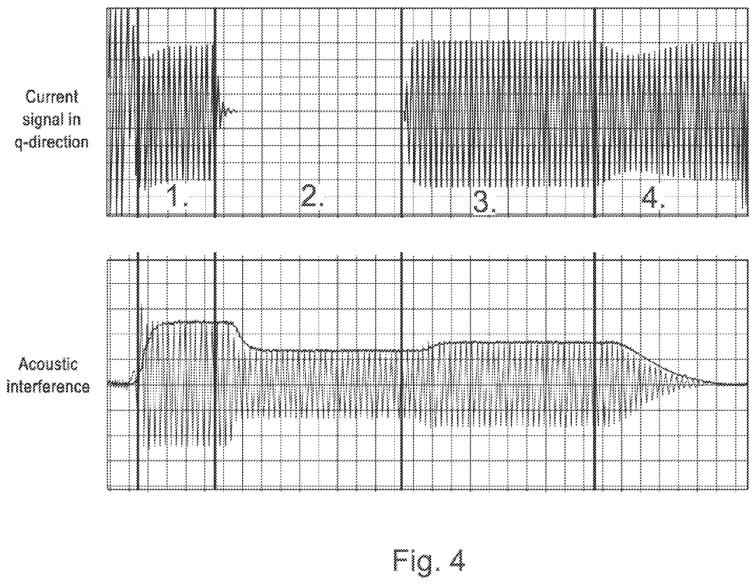

For this purpose, as shown in FIG. 4, an operating point of the electric machine can first be adjusted in a time period 1 and the operating point can also remain adjusted during an application of the first current test signal and the second current test signal so that an exact determination of the system function for the adjusted operating point is ensured. However, this is not strictly necessary.

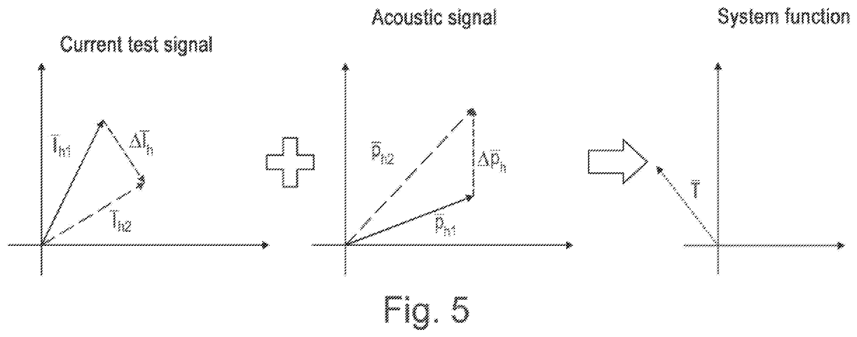

A first current test signal is then applied to the stator windings of the electric machine in time period 2. As shown in FIG. 4, the first current test signal in the present embodiment is a zero signal. This means that no current is applied to the stator windings of the electric machine 5 during time period 2. In addition, an acoustic system response is recorded in time period 2 and filtered for the individual frequencies as described above. In the vector diagram in FIG. 5, the first current test signal is, by way of example, indicated for a frequency as \vec{ΔIₕ₁} and the acoustic system response obtained thereby as \vec{pₕ₁}.

In time period 3, a second current test signal is applied to the stator windings of the electric machine. In this regard, the second current test signal is different from the first current test signal so that a different acoustic system response is also recorded in the time period 3, as shown in FIG. 4. In the vector diagram in FIG. 5, the second current test signal is, by way of example, indicated for a frequency as \vec{Iₕ₂} and the acoustic system response obtained thereby as \vec{pₕ₂}. In addition, the vector diagrams show a difference \vec{ΔIₕ} between the second and the first current test signal and a difference \vec{Δp} between the second and the first acoustic system response.

The inverse system function \vec{T⁻¹} can then be determined using the following equation (2).

$$\vec{{T}^{- 1}} = \vec{\frac{Δ {p}_{h}}{\vec{Δ {I}_{h}}}} = \frac{\vec{{p}_{h 2}} - \vec{{p}_{h 1}}}{\vec{{I}_{h 2}} - \vec{{I}_{h 1}}} \qquad Equation ( 2 )$$

By inverting the inverse system function, the system function indicating a relationship between the acoustic system response and the current signal can now be obtained (see equation (3)):

$$\vec{T} = \frac{1}{\vec{{T}^{- 1}}} \qquad Equation ( 3 )$$

The system response \vec{T} therefore provides a phase and an amplitude response from the acoustic system response to the current signal at the frequency under consideration. The system function \vec{T} can now be used to determine a control signal for injecting current harmonics into the electric machine 5 so that the acoustic interference signal is reduced or eliminated.

For this purpose, as described above and shown in FIG. 3, the complex acoustic interference signal is input into the section 11 as a deviation of the measured acoustic signal from the target acoustic signal and complex-multiplied by the system function in order to determine the complex fault current for a predetermined frequency. This relationship is shown in equation (4):

$$\vec{{I}_{e r r}} = \vec{{p}_{e r r}} \cdot \vec{T} \qquad Equation ( 4 )$$

Here, \vec{Iₑᵣᵣ} is the complex fault current, \vec{pₑᵣᵣ} is the acoustic interference signal and \vec{T} is the system function. The complex fault current \vec{Iₑᵣᵣ} can then be input into the PI controller 12 in order to produce the control signal, which is then used by the power electronics unit 4 or a control unit of the power electronics unit 4, as shown in FIG. 1, to inject the corresponding current harmonics into the electric machine 5 together with the fundamental wave current or to inject them into the stator windings of the electric machine 5.

It has been found to be advantageous if a time required to adjust the second current test signal is measured between time periods 2 and 3. The measured time can then be used to set the parameters of the PI controller 12.

An injection of current harmonics is shown in FIG. 4 in the time period 4. It can be seen that the acoustic interference signal can be effectively reduced and/or eliminated by applying the corresponding current harmonics.

It should be noted that it is not necessary to determine the system function again for each injection of current harmonics, as the system function can be used multiple times. The system function can be determined, for example, when the electric machine 5 is started, i.e., when an electric vehicle in which the electric machine 5 is used is started, and can be used for the duration of the journey.

Furthermore, in the time period 4, a variable of the acoustic interference signal after injection of the current harmonics can be determined and a new system function can be determined and then used in the time period 4 if the acoustic interference signal, i.e., the deviation of the measured acoustic signal from the acoustic interference signal, is greater than a predetermined value. In order to determine the variable of the acoustic interference signal, a predetermined time can be waited after the current harmonics have been applied until the current harmonics in the stator windings have been adjusted.

In addition, different system functions can be determined and used on the basis of the operating point and/or a rotational speed of the electric machine and/or parameters of the electric machine and/or a power electronics unit for controlling the electric machine. As a result, the corresponding system function can be selected appropriately so that the acoustic interference signal can be effectively reduced and/or eliminated under different operating conditions of the electric machine.

### LIST OF REFERENCE SIGNS

1 Control unit
2 Filter section
3 Control section
4 Power electronics unit
5 Electric machine
6 Drive train
7 Acoustic sensor
8 High-pass filter section
9 Demodulation section
10 Low-pass filter section
11 Section for complex multiplication
12 PI controller

1. A method for reducing an acoustic interference signal of an electric machine, in which:
a) a first current test signal (\vec{Iₕ₁}) is input and an associated first acoustic system response (\vec{pₕ₁}) is recorded;
b) a second current test signal (\vec{Iₕ₂}), which differs from the first current test signal (\vec{Iₕ₁}), is input and an associated second acoustic system response (\vec{pₕ₂}) is recorded;
c) a system function (\vec{T}) is determined on the basis of the first and second acoustic system responses (\vec{pₕ₁},\vec{pₕ₂}) and the first and second current test signals (\vec{Iₕ₁},\vec{Iₕ₂}); and;
d) current harmonics are injected into stator windings of the electric machine using the system function (\vec{T}), in order to reduce the acoustic interference signal, which corresponds to a deviation of an acoustic signal, measured during operation of the electric machine, from a target acoustic signal.

2. The method according to claim 1, wherein an operating point of the electric machine is adjusted prior to step a) for inputting the first current test signal (\vec{Iₕ₁}) and the operating point is also adjusted during step b) for inputting the second current test signal (\vec{Iₕ₂}).

3. The method according to claim 2, wherein one of the first current test signal (\vec{Iₕ₁}) and the second current test signal (\vec{Iₕ₂}) is a zero signal.

4. The method according to claim 3, wherein in step d) the deviation of the acoustic signal is multiplied by the system function (\vec{T}), and a fault current (\vec{Iₑᵣᵣ}) determined thereby is corrected for via a PI controller.

5. The method according to claim 4, wherein a time required to adjust the second current test signal (\vec{Iₕ₂}) is recorded between steps b) and c) in order to determine parameters of the PI controller.

6. The method according to claim 5, wherein step d) is performed using the system function (\vec{T}) multiple times.

7. The method according to claim 6, wherein in step d) a variable of the acoustic interference signal is determined after injection of the current harmonics.

8. The method according to claim 7, wherein a new system function (\vec{T}) is determined by performing steps a) to c) again and then used in step d) if the variable of the acoustic interference signal is greater than a predetermined value.

9. The method according to claim 7, wherein different system functions (\vec{T}) are determined and used on the basis of at least one of the operating point, a rotational speed of the electric machine, parameters of the electric machine, and a power electronics unit for controlling the electric machine.

10. (canceled)

11. A method for reducing an acoustic interference signal of an electric machine, comprising the steps of:
inputting a first current test signal;
recording a first acoustic system response associated with the first current test signal;
inputting a second current test signal that differs from the first current test signal;
recording a second acoustic system response associated with the second current test signal;
determining a system function based on the first and second acoustic system responses and the first and second current test signals; and
injecting current harmonics into a stator winding of the electric machine using the system function, such that the acoustic interference signal is reduced.

12. The method of claim 11, wherein the acoustic interference signal corresponds to a deviation of an acoustic signal of the electric machine that is measured during operation of the electric machine from a target acoustic signal.

13. The method of claim 11, wherein the first current test signal is a zero signal.

14. The method of claim 11, wherein the second current test signal is a zero signal.

15. The method of claim 12, wherein, in the step of injecting the current harmonics into the stator winding using the system function, the deviation of the acoustic signal is multiplied by the system function, and a fault current determined thereby is corrected for via a PI controller.

16. The method of claim 11, wherein, in the step of injecting the current harmonics into the stator winding using the system function, a variable of the acoustic interference signal is determined after injection of the current harmonics.

17. The method of claim 11, wherein the step of injecting the current harmonics into the stator winding using the system function is performed multiple times.
